(19) United States
(12) Patent Application Publication
(10) Pub. No.: US 2020/0353342 A1
(43) Pub. Date: Nov. 12, 2020

(54) Stimulus For Performance Enhancement In Sports Training

(71) Applicants: Taras Josaphat Konrad, San Diego, CA (US); Rachel Teresa Konrad, San Diego, CA (US)

(72) Inventors: Taras Josaphat Konrad, San Diego, CA (US); Rachel Teresa Konrad, San Diego, CA (US)

(21) Appl. No.: 16/407,212

(22) Filed: May 9, 2019

(51) Int. Cl. A63B 71/06; H04W 4/029; G09B 19/00; A63B 24/00

(52) U.S. Cl. CPC A63B 71/0686; H04W 4/029; G06F 3/04847; G09B 19/0038; A63B 24/0062; A63B 71/0622

(57) ABSTRACT

An electronic device and a method employing a pace regulation system (PRS) for regulating a pace of a user are provided. The position tracking system (PTS) continuously tracks a position of the user wearing the electronic device on or near earth. The movable projection system (MPS) projects an image on earth at a distance and an angle computed by the PRS. The PRS receives inputs from the user, computes the distance and the angle for the projection of the image on the earth by the MPS based on the received inputs from the user and continuously tracks position of the user from the PTS, positions the MPS based on the continuously computed distance and the continuously computed angle. The PRS stops the projection of the image by the MPS when a differential between the desired pace and the calculated pace of the user is outside a preconfigured pace differential.

### BACKGROUND

Sports enthusiasts continuously look for ways to improve their performance and competence. Research shows that external stimulus can have a significant effect on physical accomplishments. Several products on the market cater to the ever-increasing need for training accessories. An example of this product is the line-following robot, BeatBot, from Puma™. BeatBot is a track robot for sprinters, a pacer that can be taken by users to athletics tracks and used to race against, to enable the users to improve their performance and achieve better results. Some footwear include sensors and associated electronics that not only gather data but also improve characteristics of the shoe to enable the user to run faster. An example of such footwear is the Intelligent Level 1.1 by Adidas™. These devices provide real-time solutions to improve performance of a user in athletics. However, these devices require apparatus that is not worn by the user and/or need additional devices to help track the performance of the user. Moreover, these devices are not self-sufficient in that they do not address the requirements of both real-time stimulus and performance tracking by themselves.

Also, on the market are activity tracking devices that can be worn on the wrist, chest, or arms that track intensive activities of the wearer and provide detailed information about their activities, which could provide motivation to increase physical activity. Furthermore, applications have been developed on computing user devices, for example, smart phones, smart watches, tablet computing devices, personal digital assistants, and other communication devices, for interfacing with sensors worn on the body of the user to gather data on sporting activities engaged in by the user. An ecosystem is developed around these sensors, user devices and the corresponding applications using the Internet to motivate the sports user to maintain the user's performance and improve the user's performance These solutions do not involve any visual stimulation that athletes can compete against while training.

Conventional methods to spur athletes to improve their performance lack an ability to be self-sufficient regarding real-time motivation for performance enhancement and simultaneous performance tracking. Furthermore, to achieve both goals of real-time stimulus, especially visual stimulation, and performance tracking at the same time, the conventional methods need more than one light-weight device that can be worn by the user.

Hence, there is a long felt but unresolved need for an electronic device and a method that provides real-time stimulus for performance enhancement and performance tracking useable for real-time stimulation and subsequent review. Moreover, there is a need for an electronic device and a method that continuously monitors the performance of a user to update a corresponding visual stimulation for the user in real-time. Furthermore, there is a need for an electronic device that is wearable and light-weight while achieving the requirements of stimulation and performance tracking.

### SUMMARY OF THE INVENTION

This summary is provided to introduce a selection of concepts in a simplified form that are further disclosed in the detailed description of the invention. This summary is not intended to determine the scope of the claimed subject matter.

The electronic device and the method disclosed herein address the above recited need for real-time stimulus for performance enhancement and performance tracking useable for real-time stimulation and subsequent review. Moreover, the electronic device and the method disclosed herein continuously monitor the performance of a user to update a corresponding visual stimulation for the user in real-time. Furthermore, the electronic device disclosed herein is wearable and light-weight while achieving the requirements of stimulation and performance tracking.

The electronic device and the method disclosed herein employ a pace regulation system comprising at least one processor configured to execute computer program instructions for regulating the pace of a user. In an embodiment, the electronic device, which is worn by the user on or near earth, comprises a position tracking system, a movable projection system, a monitoring system, a non-transitory computer readable storage medium, at least one processor, and a touch-enabled display screen. The electronic device is secured to the user by multiple fastening methods. The position tracking system continuously tracks the position of the user using one or more global positioning systems and wireless networks. The movable projection system projects an image on earth at a distance and an angle computed by the pace regulation system. The monitoring system monitors vital signs of the user. The non-transitory computer readable storage medium stores computer program instructions defined by the pace regulation system. The processor is communicatively coupled to the non-transitory computer readable storage medium executes the defined computer program instructions. The touch-enabled display screen displays a graphical user interface provided by the pace regulation system.

The pace regulation system comprises a user interface module, a computation module, and a positioning module. The user interface module receives inputs from the user via the graphical user interface. The received inputs from the user comprise a desired pace and a desired starting point through the graphical user interface. The user interface module provides the graphical user interface to the touch-enabled display screen and displays training information on the provided graphical user interface. The computation module in the pace regulation system continuously computes the distance and the angle for the projection of the image on the earth by the movable projection system based on the received inputs from the user and the continuously tracked position of the user from the position tracking system. The computation module also calculates the pace of the user based on the continuously tracked position of the user from the position tracking system. The computation module synthesizes the training information displayed by the user interface module on the provided graphical user interface. The synthesized training information comprising the inputs received from the user, duration of training, the pace of the user, calories burned by the user, the vital signs of the user monitored by the monitoring system, distance covered by the user, and time of day. The positioning module in the pace regulation system positions the movable projection system based on the continuously computed distance and the continuously computed angle from the computation module. To ensure the user maintains the desired pace, the pace regulation system stops the projection of the image by the movable projection system when a differential between the desired pace and the pace of the user calculated by the computation module is outside a preconfigured pace differential.

In an embodiment, the electronic device, which is worn by the user, comprises a communication system, a movable projection system, a non-transitory computer readable storage medium, and at least one processor. The communication system continuously communicates with a user device. The movable projection system projects an image on earth at a distance and an angle computed by the pace regulation system. The pace regulation system comprises an acquisition module, a computation module, and a positioning module. The acquisition module continuously acquires a position of the user wearing the electronic device on or near earth and acquires inputs from the user from the user device via the communication system. The computation module continuously computes the distance and the angle for the projection of the image on the earth by the movable projection system based on the continuously acquired position of the user and the acquired inputs from the user. The computation module calculates the pace of the user based on the continuously acquired position of the user. The positioning module positions the movable projection system based on the continuously computed distance and continuously computed angle from the computation module. The pace regulation system stops the projection of the image by the movable projection system when the differential between the desired pace and the pace of the user is outside a preconfigured pace differential.

In one or more embodiments, related systems comprise circuitry and/or programming for effecting the methods disclosed herein. The circuitry and/or programming can be any combination of hardware, software, and/or firmware configured to effect the methods disclosed herein depending upon the design choices of a system designer. Also, in an embodiment, various structural elements can be employed depending on the design choice of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 exemplarily illustrates an electronic device employing a pace regulation system for regulating a pace of a user.

FIG. 2 exemplarily illustrates an electronic device employing a pace regulation system for regulating a pace of a user with a communication system.

FIG. 3 exemplarily illustrates the position of the electronic device on the user's body with fastening mechanisms.

FIG. 4A exemplarily illustrates the position of the laser on the electronic device.

FIG. 4B exemplarily illustrates the position of the electronic device on the user's body to project a pacing image.

FIG. 5 exemplarily illustrates a flowchart to project an image based on user inputs.

FIG. 6 exemplarily illustrates a flow diagram showing how the received user input is transformed to a pacing image of the user.

FIG. 7 exemplarily illustrates a flow diagram with an electronic device showing the mechanism for laser movement to obtain the pacing image of the user.

FIG. 8 exemplarily illustrates a method for regulating a pace of a user by the pace regulation system.

FIG. 9 exemplarily illustrates an architectural diagram of the pace regulation system for regulating a pace of a user.

### DETAILED DESCRIPTION OF THE INVENTION

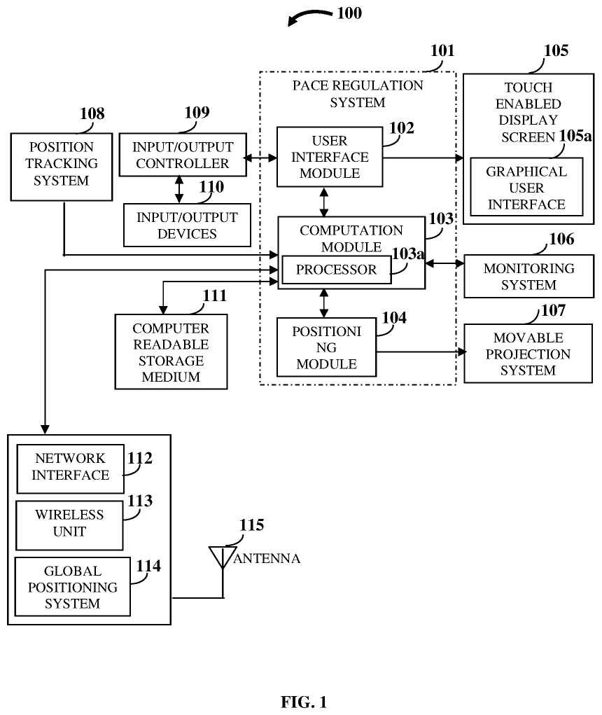

FIG. 1 exemplarily illustrates an electronic device 100 employing a pace regulation system 101 for regulating the pace of a user. The electronic device 100 is a wearable device that enables the user to exercise at a pace set by the user using a visible image projected on a surface, for example, a ground surface of earth, a wall in the proximity of the electronic device 100 by a projection system. As used herein, the term “pace” refers to the speed at which a user or something moves. The electronic device 100 can also be used to aid in achieving a goal while training for specific activities; the goal is to complete an activity at a certain speed and time. The training activities, for example, comprises walking, biking, running, and other activities involving velocity, i.e., distance per unit of time as a primary metric of the activity. The electronic device 100, is for example, mobile phones, smartphones, personal digital assistants, wearable computing devices such as the Google Glass® of Google Inc., the Apple Watch® of Apple Inc., etc., touch centric devices, portable electronic devices, network enabled computing devices, interactive network enabled communication devices, etc. The electronic device 100 is a rechargeable device and acts as a visual pace guide to the user involved in the training activities. The electronic device 100 improves the performance of the user involved in different activities by providing a visual stimulation and a constant reminder of a user's set goal.

The electronic device 100 disclosed herein employs a pace regulation system 101 comprising a non-transitory computer readable storage medium 111 to store computer program instructions defined by the pace regulation system 101 and at least one processor 103a communicatively coupled to the non-transitory computer readable storage medium 111 configured to execute defined computer program instructions for regulating the pace of a user. In an embodiment, the electronic device 100 comprises a position tracking system 108, a movable projection system 107, a monitoring system 106, and a touch-enabled display screen 105. The electronic device 100 is secured to the user by multiple fastening methods. The fastening methods, are for example, by a phone or a watch disposed on the user's body. The position tracking system 108 continuously tracks the position of the user wearing the electronic device 100 on or near earth. The position tracking system 108 tracks the position of the user using one or more global positioning system 114 and wireless networks 113. The image sustains the appropriate distance in relation to the user, by tracking both the user and the desired pace of the image using a global positioning system 114 or a wireless network 113. The movable projection system 107 projects an image on the ground surface of the earth at a distance and an angle computed by the pace regulation system 101. The monitoring system 106 monitors the vital signs of the user. The touch-enabled display screen 105 displays a graphical user interface 105a provided by the pace regulation system 101. In an embodiment, the electronic device 100 comprises a keypad (not shown) in addition to the touch-enabled display screen 105. In another embodiment, the electronic device 100 comprises a keypad (not shown) and a display screen 105 without a touch-screen interface. The electronic device 100 receives the input through the touch-enabled display screen 105. The touch-enabled display screen 105 is provided by a smart watch. The smart watch, is for example, the Garmin® watch of Garmin Ltd. with six buttons, the Apple Watch® of Apple Inc., etc.

In an embodiment, the pace regulation system 101 comprises a user interface module 102, a computation module 103, and a positioning module 104. The user interface module 102 receives inputs from the user via the graphical user interface 105a. The user interface module 102 provides the graphical user interface 105a to the touch-enabled display screen 105 and displays training information on the provided graphical user interface 105a. The user interface module 102 is communicatively coupled with the input/output controller 109 and input/output devices 110. The input/output controller 109 functions in the connection of graphical user interface 105a to the user interface module 102 and controls different peripheral devices, for example, input/output devices 110. The received inputs from the user comprise a desired pace and a desired starting point of an activity that the user intends to engage in. The activity comprises any activity where velocity is a key metric of the activity, without continuous and rapid change of the user's direction, for example, running and biking where the user engages in an activity to complete the activity at a certain speed and within a certain time. The computation module 103 is communicatively coupled to the user interface module 102, a positioning module 104, a position tracking system 108, a monitoring system 106, a computer readable storage medium 111, a processor 103a, a network interface 112, a wireless unit 113, and the Global Positioning System (GPS) unit 114. The network interface 112, the wireless unit 113, and the GPS 114 communicate through an antenna 115. The antenna 115 sends and receives signal to and from the electronic device 100.

In an embodiment, the computation module 103 continuously computes the distance and the angle for the projection of the image on the earth by the movable projection system 107 based on the received inputs from the user, and continuously tracks the position of the user from the position tracking system 108. The position tracking system 108 continuously tracks the position of the user on earth using the Global Positioning System (GPS), or wireless networks by communicating with the GPS unit 114 or the wireless unit 113 respectively. Based on the inputs from the user comprising the desired pace and the desired starting point and the position of the user on the earth, the computation module 103 computes a distance and an angle at which an image is projected on the earth. The computation module 103 calculates the pace of the user based on the continuously tracked position of the user from the position tracking system 108. The computation module 103 synthesizes the training information displayed by the user interface module 102 on the provided graphical user interface 105a. The synthesized training information comprises the inputs received from the user, duration of training, the pace of the user, calories burned by the user, the vital signs of the user monitored by the monitoring system 106, distance covered by the user, and time of day.

The positioning module 104 of the pace regulation system 101 positions a movable projection system 107 based on the continuously computed distance and the continuously computed angle from the computation module 103. In an embodiment, the image projected on the earth is a dot, an arrow, or a picture stored in the computer readable storage medium 111. The pace regulation system 101 displays the projected image both during the day and at night. As the position tracking system 108 continuously tracks the position of the user, the computation module 103 continuously computes the pace of the user, and updates the values of the distance and the angle for the positioning module 104 to adjust the movable projection system 107 accordingly. The projected image, thus, acts as a stimulus for the user to maintain or improve the user's pace. The pace regulation system 101 stops the projection of the image by the movable projection system 107 when the differential between the desired pace and the pace of the user calculated by the computation module 103 is outside a preconfigured pace differential. In the event that the calculated pace of the user varies from the desired pace input by the user, outside a preconfigured pace differential, the computation module 103 communicates with the movable projection system 107 via the positioning module 104 to stop the projection of the image. The user is required to maintain the user's pace in order to receive a continuous projection of the image as a stimulus to perform. The projected image is stored or removed from the electronic device 100 based on the user's prompt. Research studies show that performance is much more dependent on mental rather than physical abilities, especially in high skilled participants. A few products available in the market provide auditory pacing, or intermittent visual pacing. The electronic device 100 disclosed herein provides a constant visual reminder of the pace of the user and improves the physical performance of the user. The electronic device 100 also downloads the training information, and the downloaded training information is stored to a different electronic device. The synthesized training information comprising the inputs received from the user, duration of training, the pace of the user, calories burned by the user, the vital signs of the user monitored by the monitoring system, distance covered by the user, and time of day. The electronic device 100 is a water proof device to enable the electronic device 100 to be used by swimmers or triathletes in a pool. In an embodiment, the electronic device 100 downloads training information of an exercise session on to the electronic device 100 through the network interface 112 or the wireless unit 113.

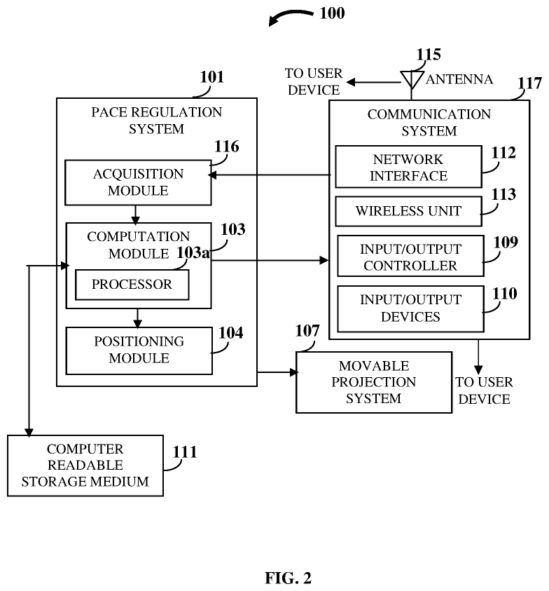

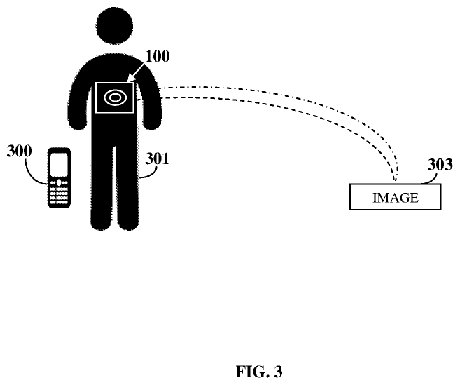

FIG. 2 exemplarily illustrates an electronic device 100 employing a pace regulation system 101 for regulating a pace of a user with a communication system 117. In an embodiment, the electronic device 100 comprises a communication system 117, a movable projection system 107, a non-transitory computer readable storage medium 111, and at least one processor 103a configured to execute the defined computer program instructions. The communication system 117 continuously communicates with a user device 300, shown in FIG. 3. The user device 300, is for example, a mobile telephone, a smart watch, etc. The communication system 117 comprises a network interface 112, a wireless unit 113, an input/output controller 109, and input/output devices 110. The communication system 117 communicates with the user device 300 through an antenna 115. The movable projection system 107 is exemplarily illustrated in the detailed description of FIG. 1. In another embodiment, the pace regulation system 101 comprises an acquisition module 116, a computation module 103, and a positioning module 104. The pace regulation system 101 is communicatively coupled with the communication system 117 of the electronic device 100.

The acquisition module 116 of the pace regulation system 101 acquires a position of the user wearing the electronic device 100 on or near earth, and acquires inputs from the user through the user device 300 via the communication system 117. The acquired inputs from the user comprise a desired pace and a desired starting point. The computation module 103 computes the distance and the angle for the projection of the image on the earth by the movable projection system 107 based on the continuously acquired position of the user and the acquired inputs from the user. The computation module 103 calculates the pace of the user based on the continuously acquired position of the user. The positioning module 104 of the pace regulation system 101 positions the movable projection system 107 based on the continuously computed distance and the continuously computed angle from the computation module 103 is exemplarily illustrated in the detailed description of FIG. 1. The pace regulation system 101 stops the projection of the image by the movable projection system 107 when the differential between the desired pace and the pace of the user calculated by the computation module 103 is outside a preconfigured pace differential, as exemplarily illustrated in the detailed description of FIG. 1.

FIG. 3 exemplarily illustrates the position of the electronic device 100 on the user's body 301 with fastening mechanisms. The electronic device 100 is securely attached to the user's body 301 by different fastening mechanisms. The fastening mechanisms comprise wearing the electronic device 100 on the wrist of the user, attaching the electronic device 100 on clothing worn by the user's, pinning the electronic device 100 on the user's shirt, using a Velcro to attach the electronic device 100, using a magnet to securely attach the electronic device 100 on the user's shirt, etc. In an embodiment, a separate line of clothing are manufactured to firmly secure or hold the electronic device 100. For example, if the user 301 is in a standing position, the electronic device 100 is positioned on the chest of the user 301. The position tracking system 108 on the electronic device 100 continuously tracks the position of the user 301 and the movable projection system 107 projects an image on earth at a distance and an angle computed by the pace regulation system 101. For example, if the user 301 enters the desired pace via the graphical user interface 105a, the computation module 103 in the pace regulation system 101 computes the distance and the angle for projection of the image on the earth. The image is then projected and positioned based on the computed distance and computed angle from the computation module 103 in the pace regulation system 101. The monitoring system 106 in the electronic device 100 monitors vital signs of the user 301. The vital signs of the user 301, for example, comprise a standing position of the user 301, walking position of the user 301, etc. When the user 301 wears the electronic device 100, the image projected moves away from the starting point at a desired inputted pace regardless of the pace of the user 301. The projection of the image stops if the user 301 is ahead, or very far behind the projected image. The axis of rotation of the projected image is, for example, 10 to 80 degrees of movement of the projected image. The exact distance from the ground is of minor significance as the error where the image projected is small compared to the distance traveled by the user 301.

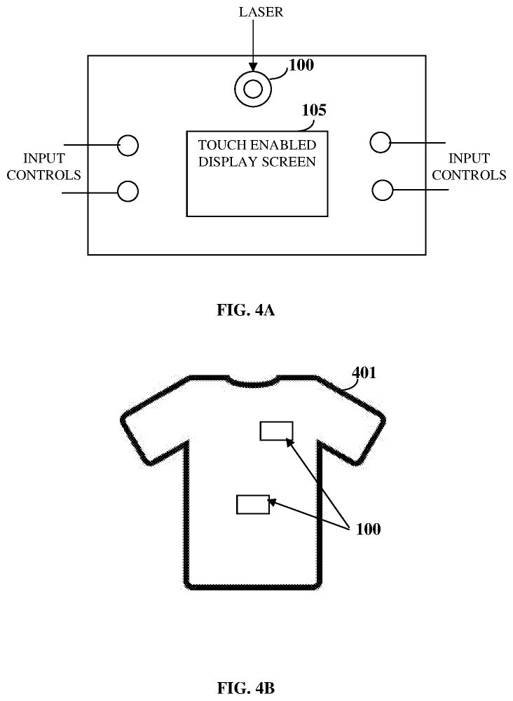

FIG. 4A exemplarily illustrates the position of the laser on the electronic device 100. The user 301 provides the input through the touch enabled display screen 105 of the electronic device 100. The touch enabled display screen 105 displays the information through the graphical user interface 105a provided by the pace regulation system 101. The user interface module 102 of the pace regulation system 101 receives input from the user 301 through the input/output devices 110. The electronic device 100 employing the pace regulation system 101 for regulating the pace of the user 301 is securely positioned to the user's 301 body. The image is projected based on the position of the user 301 and the computed distance and angle obtained from the pace regulation system 101. The projected image is controlled by an integrated image emitting source, for example, a laser mechanism. The laser mechanism is directly coupled to the electronic device 100. A laser pointer is housed on the electronic device 100 and controlled by a global positioning system (GPS) enabled program that allows the laser to project an image to the correct area in front of the user 301 corresponding with the intended inputted pace. The electronic device 100 displays the time of day, duration of the activity based on start or stop inputs from the user 301, the pace of the user 301, the inputted pace for image, and the number of calories burned by the user 301.

FIG. 4B exemplarily illustrates the position of the electronic device 100 on the user's 301 body to project a pacing image. In an embodiment, the electronic device 100 is positioned on a shirt 401 of the user 301. The electronic device 100 is securely positioned, for example, on the top right hand corner of the shirt 401 in order to compute the distance and angle for the projection of the image. In another embodiment, the electronic device 100 is positioned near the waist area of the user 301 to project the pacing image of the user 301.

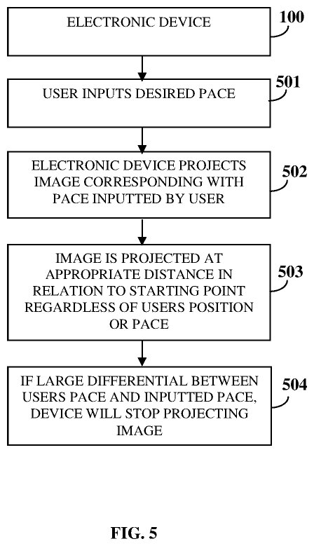

FIG. 5 exemplarily illustrates a flowchart to project an image based on user inputs. The electronic device 100 is securely positioned on the user's 301 body. The user 301 inputs 501 the desired pace through the graphical user interface 105a. The electronic device 100 employing a pace regulation system 101 projects 502 an image corresponding with the pace inputted by the user 301. The electronic device 100 displays the time at which the user 301 performs the training activities, the distance of the user 301 computed by the pace regulation system 101, the heart rate of the user 301, the number of calories burnt by the user 301, the pace of the user 301 and the inputted pace of the user 301. The electronic device 100 communicates through a wireless network 113 or a Bluetooth network. The Bluetooth network is paired to a watch or a phone of the user 301. The pace regulation system 101 projects 503 an image at an appropriate distance in relation to a starting point regardless of user's 301 position or pace. The pace regulation system 101 calculates the correct position of the image based on the starting point of the user 301 and not the current position of the user 301.

The electronic device 100 provides the user 301 real time information on the display or the projected image. The electronic device 100 stops 504 projecting the image if the differential between the user's 301 pace and the inputted pace is outside a preconfigured pace differential. In an embodiment, if the user 301 travels faster than the set pace, the image disappears in accordance with the global positioning system 114 coordinates. In another embodiment, if the user 301 travels slower than the set pace, the image disappears and emits an audible alarm to encourage the user to sustain the user's pace. For example, if the user 301 is travelling at a pace faster or slower than the predetermined pace, the projection of the image stops until the user 301 reaches within the defined distance of the position of the image. The electronic device 100 projects the directions for the user 301 based on the input coordinates to be set as the destination for the user 301. The input coordinates are set in the paired device using the global positioning system 114 or inherent mapping of the inputs received from the user through the user device 300 to change the projected image to point in the correct direction of the projected image. In an embodiment, the electronic device 100 sets the input coordinates using the global positioning system 114, inherent mapping, and a software to change the direction of the projected image to point in the correct direction of the projected image. In another embodiment, the electronic device 100 also provides a talking assistant to project the image in the right direction of the user.

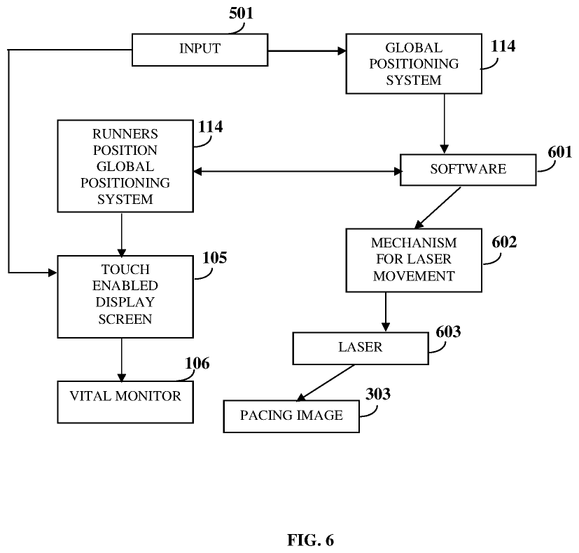

FIG. 6 exemplarily illustrates a flow diagram showing how the received user 301 input 501 is transformed to a pacing image of the user 301. In an embodiment, the electronic device 100 is a self-contained device. The flow of a self-contained device is as follows: turning on the electronic device 100, waiting for the global positioning system 114 acquisition, inputting the goal pace, starting the application and the activity, attempting to keep the pace of the user 301 with the image. The electronic device 100 uses an application programming interface to determine the exact location of the user 301. The application programming interface, is for example, an interface used in the Garmin® watch of Garmin Ltd. The user 301 inputs 501 the desired goal pace through a graphical user interface 105a. The global positioning system 114 continuously tracks the position of the user 301 wearing the electronic device 100. In an embodiment, if the user 301 performs a running activity, the user's running position is continuously tracked by the global positioning system 114. The tracked position of the user 301 is then loaded on to the pace regulation system 101 that has an in built software program, for example, a pace regulation client application to regulate the pace of the user 301. The software program is embedded in the pace regulation system 101 to calculate the correct position of the image. The image is then projected using a laser mechanism. The mechanism for laser movement 602 employs a hardware to rotate the laser. The projected image is, for example, an arrow or a large dot, attached to a gear that rotates the housing of the laser through a predetermined set of degrees. The amount of rotation is calculated by a software using the initial starting point and the global positioning system 114 mapping. The amount of rotation is also determined by calculating the appropriate distance from the user 301 based on the user's pace and the inputted pace. The projected image is turned off at an angulation of 0 and 90 relative to the user 301. The laser 603 produces the pacing image 303. The touch enabled display screen 105 displays the pace of the user 301, vital signs of the user 301, time of day, distance covered by the user 301, and calories burned by the user 301. The vitals monitor 106 is positioned on the wrist or chest of the user by a strap. The algorithm involved in the software 601 program calculates the difference of pace between the user 301 and intended pace of the user 301 rather from the starting position of the user 301 thereby allowing a front and back route via loop. The algorithm recognizes when the user 301 has turned around on the same route to determine proper pacing. The laser mechanism provides a green laser image in a housing attached to a gear. The gear rotates depending on the calculated angle and the appropriate number of degrees to move the hosing and displays arrows and other appropriate images of the user. In an embodiment, a small laser pointer, for example iPin® of Conary Enterprise Co., Ltd is used to display small laser lights and iPin fits in the headphone jack of an iPhone® of Apple Inc.

In an embodiment, the user 301 wearing the electronic device 100 inputs the desired pace via the graphical user interface 105a. The position tracking system 108 tracks the position of the user 301 using a global positioning system (GPS) 114. The user 301 then pushes the start button on the electronic device 100. The GPS 114 tracks the distance covered by the electronic device 100 and the user 301. Based on the inputted pace of the user 301, current location of the user 301, and the initial starting point of the user 301, the projection emitting hardware, for example, the laser is rotated to the proper angle to ensure the image is projected at the proper distance from the user 301. The position of the projected image is calculated using the mathematical equation, P=ID−AD, where ID refers to the inputted pace of the user 301, AD refers to the actual pace of the user 301, and P refers to the position of the user 301/distance of the projected image. The angle is calculated using the mathematical equation, tan(angle)=Opp/Adj, where Opp refers to the distance of the electronic device 100 from the ground and Adj refers to the position obtained from the previous mathematical equation. The angle is calculated by dividing the tan from both the sides. The computed angle is used to rotate the laser to a correct position to project the image of the user 301 at a correct distance.

In an embodiment, the user 301 inputs the desired pace and the global positioning system (GPS) 114 tracks the distance covered by the electronic device 100 and the user 301. The projection emitting hardware is rotated to the proper angle to ensure the image is projected at the proper distance from the user 301 based on the inputted pace, average actual pace of the user 301, and the time elapsed by the user 301. The position of the image is calculated using the mathematical equation, P=T(IP)−T(AP) where IP refers to the inputted pace, AP refers to the actual pace, P refers to the position/distance of the projected image, T refers to the time elapsed by the user 301. The angle is calculated using the mathematical equation, tan(angle)=Opp/Adj, where Opp refers to the distance of the electronic device 100 from the ground, Adj refers to the position P calculated from the previous mathematical equation. The angle is obtained by dividing the tan from both the sides. The computed angle is the correct angle that the laser is projected to provide the image at a correct distance.

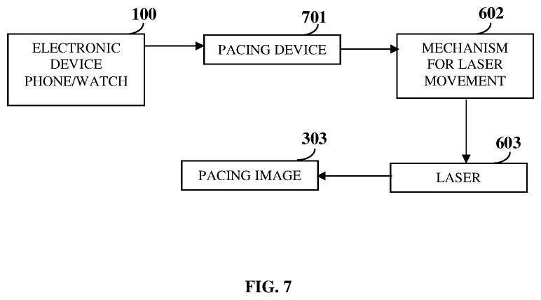

FIG. 7 exemplarily illustrates a flow diagram with an electronic device 100 showing the mechanism for laser movement 602 to obtain the pacing image of the user 301. In an embodiment, the self-contained device is replaced by a smart phone or a watch. The flow comprises turning on the electronic device 100, waiting for tethering of user devices 300, waiting for the global positioning system acquisition, inputting the pace on the smart phone or the watch, beginning the activity, and attempting to keep the pace of the user 301 with the image. The self-contained device is attached, for example, to a bike or the shirt of a user. The watch requires a software application to control the pace of the user 301. The touch enabled display screen 105 inputs vitals of the user, and the global positioning system 114 of the self-contained device is replaced by the phone or the watch. The smart phone or watch displays the information of the user 301, for example, heart rate and other vital signs of the user 301. The electronic device 100 is linked using a Wi-Fi network or a Bluetooth network. The electronic device 100 supports the provision for laser hardware to project a pacing image of the user.

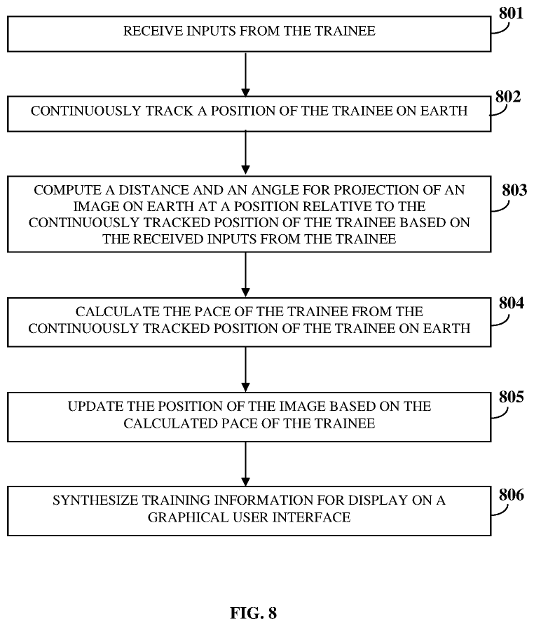

FIG. 8 exemplarily illustrates a method for regulating the pace of a user 301 by the pace regulation system 101. The method disclosed herein comprises the pace regulation system 101 comprising at least one processor 103a configured to execute computer program instructions for regulating the pace of a user 301. The pace regulation system 101 receives 801 inputs from the user 301 by the user interface module 102. The received inputs from the user 301 comprise a desired pace and a desired starting point. The pace regulation system 101 continuously tracks 802 a position of the user 301 on earth by the position tracking system 108 using one or more global positioning system 114 and wireless networks 113. The pace regulation system 101 computes 803 a distance and an angle for projection of an image on earth at a position relative to the continuously tracked position of the user 301 based on the received inputs from the user by the computation module 102. The pace regulation system 101 calculates 804 the pace of the user 301 from the continuously tracked position of the user 301 on earth. The pace regulation system 101 updates 805 the position of the image based on the calculated pace of the user 301 by the positioning module 104. The updating of the position of the image comprises stopping the projection of the image when a differential between the desired pace and the calculated pace of the user 301 is outside a preconfigured pace differential. The pace regulation system 101 synthesizes 806 training information for display on a graphical user interface 105a by the computation module 103. The synthesized training information comprises the inputs received from the user 301, duration of training, the calculated pace of the user 301, calories burned by the user 301, vital signs of the user 301, distance covered by the user 301, and time of day. The user interface module 102, the computation module 103, and the positioning module 104 of the pace regulation system 101 is exemplarily illustrated in the detailed description of FIG.1.

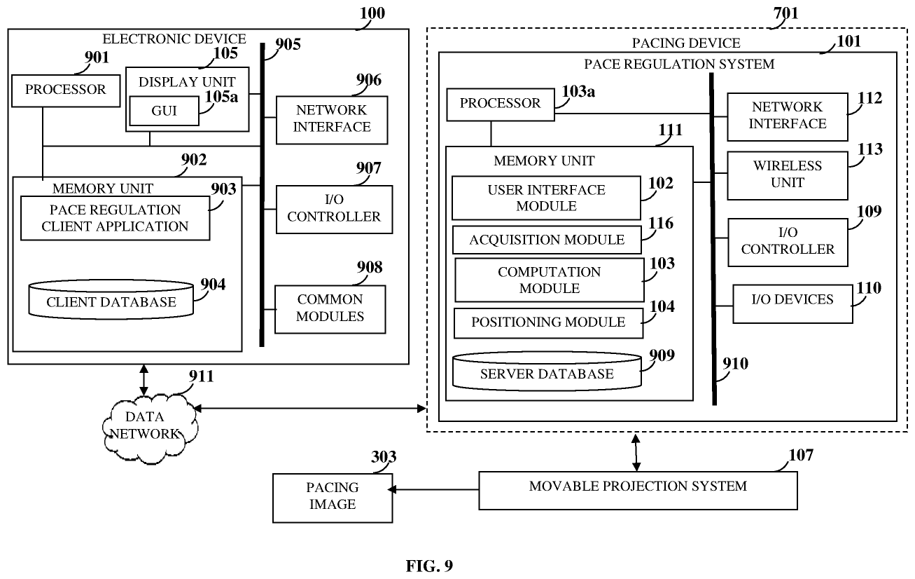

FIG. 9 exemplarily illustrates an architectural diagram of the pace regulation system 101 for regulating a pace of a user. The system 900 disclosed herein comprises a pace regulation client application 903 installed on the electronic device 100 in communication with the pace regulation system 101 via a data network 911, for example, a short range network or a long range network. The electronic device 100 is disclosed in the detailed description of FIG. 1. The electronic device 100 comprises hybrid computing devices that combine the functionality of multiple devices. Examples of hybrid computing devices comprise a cellular telephone that includes media player functionality, a cellular telephone that includes game and multimedia functions, and a portable device that receives electronic mail (email), supports mobile telephone calls, has media player functionality, and supports web browsing. The pace regulation system 101 is accessible to users, for example, through a broad spectrum of technologies and devices such as internet enabled cellular phones, tablet computing devices, etc. The pace regulation system 101 comprises the user interface module 102, the computation module 103, the positioning module 104, the acquisition module 116 as disclosed in the detailed descriptions of FIGS. 1-2.

The electronic device 100 and the pace regulation system 101 are computer systems that are programmable using high level computer programming languages. In an embodiment, the pace regulation client application 903 is implemented on the electronic device 100 using programmed and purposeful hardware. As exemplarily illustrated in FIG. 9, the electronic device 100 and the pace regulation system 101 comprise non-transitory computer readable storage media, for example, memory units 902, and 111 respectively, for storing program instructions, applications, and data. As used herein, “non-transitory computer readable storage media” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wires, fiber optic cables, modems, etc., including wires that constitute a system bus coupled to a processor, for example, 901, or 103a.

The pace regulation client application 903 and a client database 904 of the electronic device 100 are installed and stored in the memory unit 902 of the electronic device 100. A server database 909 is installed and stored in the memory unit 111 of the pace regulation system 101. The memory unit 902 of the electronic device 100 stores computer program instructions defined by modules, for example, 106, 107, 108, etc., of the electronic device 100. Similarly, the memory unit 111 of the pace regulation system 101 stores computer program instructions defined by modules, for example, 102, 103, 104, 116 etc., of the pace regulation system 101. The memory units 902 and 111 of the electronic device 100, and the pace regulation system 101 are, for example, random access memories (RAMs) or other types of dynamic storage devices that store information and instructions for execution by the processors 901 and 103a of the electronic device 100, and the pace regulation system 101. The memory units 902 and 103a also store temporary variables and other intermediate information used during execution of the instructions by the processors 901 and 103a respectively. The electronic device 100 and the pace regulation system 101, each further comprises a read only memory (ROM) or another type of static storage device that stores static information and instructions for the processors 901 and 103a respectively.

The processors 901 and 103a are communicatively coupled to the memory units 902 and 111 of the electronic device 100, and the pace regulation system 101. The processor 901 of the electronic device 100 executes computer program instructions defined by the pace regulation client application 903. The processor 103a of the pace regulation system 101 executes computer program instructions defined by the server application of the pace regulation system 101. The processors 901 and 103a of the electronic device 100, and the pace regulation system 101, refer to any one or more microprocessors, central processing unit (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, each of the processors 901 and 103a is implemented as a processor set comprising, for example, a programmed microprocessor and a math or graphics co-processor. The processor 901 and 103a are selected, for example, from the Intel® processors such as the Itanium® microprocessor or the Pentium® processors, Advanced Micro Devices)(AMD® processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The system 900 disclosed herein is not limited to employing the processors 901 and 103a. In an embodiment, the system 900 employs controllers or microcontrollers.

As exemplarily illustrated in FIG. 9, the electronic device 100, the pace regulation system 101 further comprise data buses 905 and 910, network interfaces 906 and 112, input/output (I/O) controllers 907 and 109, and common modules 908, where the common modules 908 comprise input devices, output devices, fixed media drives such as hard drives, removable media drives for receiving removable media, etc. The data bus 905 of the electronic device 100 permits communication between the modules, for example, 106, 107, 108, etc., of the electronic device 100. The data bus 910 of the pace regulation system 101 permits communication between the modules, for example, 102, 103, 104, 116, etc., of the pace regulation system 101. The network interfaces 906 and 112 enable connection of the electronic device 100, and the pace regulation system 101, to the data network 911. In an embodiment, the network interfaces 906 and 112 of the electronic device 100 and the pace regulation system 101 are provided as interface cards also referred to as line cards. The network interfaces 906 and 112 are, for example, one or more of interfaces implementing Wi-Fi® of Wi-Fi Alliance Corporation, FireWire® interfaces of Apple Inc., wide area network (WAN) interfaces, interfaces using serial protocols, interfaces using parallel protocols, Ethernet communication interfaces, asynchronous transfer mode (ATM) interfaces, high speed serial interfaces (HSSIs), fiber distributed data interfaces (FDDIs), interfaces based on transmission control protocol (TCP)/internet protocol (IP), interfaces based on wireless communications technology such as satellite technology, radio frequency (RF) technology, near field communication, etc. The I/O controllers 907 and 109 of the electronic device 100, and the pace regulation system 101 control input actions and output actions performed by the electronic device 100, and the pace regulation system 101.

In an embodiment, the electronic device 100 further comprises a display unit 105 that displays the graphical user interface (GUI) 105a rendered by the pace regulation client application 903. The display unit 105 is, for example, a video display, a liquid crystal display, a plasma display, an organic light emitting diode (OLED) based display, etc. The display unit 105, via the GUI 105a, displays information, for example, heart rate of the user, number of calories burned by the user, etc. The pace regulation client application 903 renders the GUI 105a on the display unit 105 to receive user inputs, for example, a desired pace of the user. The GUI 105a is, for example, an online web interface, a web based downloadable application interface, a mobile based downloadable application interface, etc.

The client database 904 in the electronic device 100, and the server database 909 in the pace regulation system 101 can be any storage area or medium that can be used for storing the desired pace of the user, and other vital signs of the user. In an embodiment, the client database 904 and the server database 909 are external databases, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase® database of the Apache Software Foundation, etc. In an embodiment, the client database 904 and the server database 909 can also be locations on respective file systems of the electronic device 100, and the pace regulation system 101. In an embodiment, the client database 904, and the server database 909 can be remotely accessed by the electronic device 100, and the pace regulation system 101, via the data network 911. In another embodiment, the client database 904, and the server database 909 are configured as cloud based databases implemented in a cloud computing environment, where computing resources are delivered as a service over the data network 911. As used herein, “cloud computing environment” refers to a processing environment comprising configurable computing physical and logical resources, for example, networks, servers, storage media, virtual machines, applications, services, etc., and data distributed over a network, for example, the internet. The cloud computing environment provides on-demand network access to a shared pool of the configurable computing physical and logical resources.

Computer applications and programs are used for operating the pace regulation client application 903 on the electronic device 100, and the server application on the pace regulation system 101. The programs are loaded onto the fixed media drives and into the memory units 902 and 111 of the electronic device 100, and the pace regulation system 101, via the respective removable media drives. In an embodiment, the computer applications and programs are loaded directly into the memory units 902 and 111 of the electronic device 100, and the pace regulation system 101, via the data network 911.

Each of the processors 901 and 103a of the electronic device 100 and the pace regulation system 101 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., etc. The electronic device 100, and the pace regulation system 101 employ their respective operating systems for performing multiple tasks. The operating systems of the electronic device 100, and the pace regulation system 101 are responsible for management and coordination of activities and sharing of their respective resources. The operating systems further manage security, peripheral devices, and network connections. The operating systems recognize, for example, inputs provided by a user, files, and directories stored locally on the respective fixed media drives. The operating systems of the electronic device 100, and the pace regulation system 101 execute different programs using the processors 901 and 103a. The processors 901 and 103a and the operating systems of the electronic device 100 and the pace regulation system 101 define a computer platform for which application programs in high level programming languages are written.

The processor 901 of the electronic device 100 retrieves instructions defined by the position tracking system 108, the movable projection system 107, and the monitoring system 106 exemplarily illustrated in the detailed description of FIG. 1, in the memory unit 902 of the electronic device 100, for performing respective functions disclosed in the detailed description of FIG. 1. The processor 901 of the electronic device 100 retrieves instructions for executing the modules 108, 107, 106. The processor 103a of the pace regulation system 101 retrieves instructions defined by the user interface module 102, the computation module 103, the acquisition module 116, and the positioning module 104 of the pace regulation system 101 exemplarily illustrated in FIG. 1, in the memory unit 111 of the pace regulation system 101, for performing respective functions disclosed in the detailed description of FIG. 1. The processor 103a of the pace regulation system 101 retrieves instructions for executing the modules 102, 103, 104, 116.

A program counter determines the location of the instructions in each of the memory units 902 and 111. The program counter stores a number that identifies the current position in the program of each of the modules, for example 108, 107 of the electronic device 100, the modules, for example, 102, 103, 104, 116, etc., of the pace regulation system 101. The instructions fetched by the processors 901 and 103a from the memory units 902 and 111 respectively, after being processed are decoded. The instructions are stored in an instruction register in each of the processors 901 and 103a. After processing and decoding, the processors 901 and 103a execute the instructions, thereby performing one or more processes defined by those instructions.

At the time of execution, the instructions stored in the instruction register are examined to determine the operations to be performed. The processors 901 and 103a of the electronic device 100, and the pace regulation system 101 then perform the specified operations. The operations comprise arithmetic operations and logic operations. The respective operating systems perform multiple routines for performing a number of tasks required to assign the memory units 902 and 111 for execution of the modules, for example, 108, 107, 106 on the electronic device 100, the modules, for example, 102, 103, 104, 116, etc., on the pace regulation system 101. The tasks performed by the respective operating systems comprise, for example, assigning memory to the modules, for example, 106, 107, 108 on the electronic device 100, the modules, for example, 102, 103, 104, 116, etc., on the pace regulation system 101, and to data used by the electronic device 100, and the pace regulation system 101 moving data between the memory units 902 and 111 and disk units, and handling input/output operations. The respective operating systems perform the tasks on request by the operations and after performing the tasks, the respective operating systems transfer the execution control back to the processors 901 and 103a. The processors 901 and 103a continue the execution to obtain one or more outputs. The outputs of the execution of the modules, for example, 106, 107, 108 on the electronic device 100, the modules, for example, 102, 103, 104, 116, etc., on the pace regulation system 101, are displayed to the user on the graphical user interface (GUI) 105a of the electronic device 100.

For purposes of illustration, the detailed description refers to the electronic device 100, and the pace regulation system 101 run locally as individual computer systems; however, the scope of the method and the system 900 disclosed herein is not limited to the electronic device 100 and the pace regulation system 101 run locally on individual computer systems via their respective operating systems and processors 901 and 103a, but may be extended to run remotely over the data network 911 by employing web browsers and remote servers, mobile phones, or other electronic devices. In an embodiment, one or more portions of the system 900 disclosed herein are distributed across one or more computer systems (not shown) coupled to the data network 911.

The non-transitory computer readable storage media disclosed herein stores computer program codes comprising instructions executable by the processors 901, 103a for regulating a pace of a user. In the non-transitory computer readable storage media of the pace regulation system 101, the computer program codes comprise a first computer program code for receiving inputs from the user; a second computer program code for continuously tracking a position of the user on earth; a third computer program code for computing a distance and an angle for projection of an image on earth at a position relative to the continuously tracked position of the user based on the received inputs from the user; a fourth computer program code for calculating the pace of the user from the continuously tracked position of the user on earth; a fifth computer program code for updating the position of the image based on the calculated pace of the user; and a sixth computer program code for synthesizing training information for display on a graphical user interface.

In an embodiment, the computer program codes further comprise a seventh program code for providing the graphical user interface to the touch-enabled display screen and display training information on the provided graphical user interface. In another embodiment, the computer program codes further comprise an eighth program code for calculating the pace of the user based on the continuously tracked position of the user from the position tracking system. The computer program codes further comprise a ninth program code for synthesizing the training information displayed by the user interface module on the provided graphical user interface. The computer program codes further comprise a tenth program code for mapping the input coordinates and directions of the projected image of the user.

The computer program codes further comprise one or more additional computer program codes for performing additional steps that may be required and contemplated for regulating the pace of the user. In an embodiment, a single piece of computer program code comprising computer executable instructions performs one or more steps of the method disclosed herein for regulating the pace of the user. The computer program codes comprising computer executable instructions are embodied on the non-transitory computer readable storage media. The processors 901 and 103a of the electronic device 100 and the pace regulation system 101 retrieve their respective computer executable instructions and execute them. When the computer executable instructions are executed by the processors 901 and 103a, the computer executable instructions cause the processors 901 and 103a to perform the steps of the method for regulating the pace of the user.

It is apparent in different embodiments that the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in various manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Peri®, Python®, Visual Basic®, hypertext preprocessor (PHP), Microsoft® .NET, Objective-C®, etc. . In an embodiment, the computer program codes or software programs are stored in one or more mediums as object code. In another embodiment, various aspects of the method and the pace regulation system 101 exemplarily illustrated in FIG. 9, disclosed herein are implemented in a non-programmed environment comprising documents created, for example, in a hypertext markup language (HTML), an extensible markup language (XML), or other format that render aspects of a graphical user interface (GUI) exemplarily illustrated in FIG. 1, or perform other functions, when viewed in a visual area or a window of a browser program. In another embodiment, various aspects of the method and the pace regulation system 101 disclosed herein are implemented as programmed elements, or non-programmed elements, or any suitable combination thereof.

Where databases are described such as the client database 904 and the server database 909 as exemplarily illustrated in FIG. 9, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the pace regulation system 101, the databases are integrated to communicate with each other for enabling simultaneous updates of data linked across the databases, when there are any updates to the data in one of the databases.

The method and the pace regulation system 101 disclosed herein can be configured to work in a network environment comprising one or more computers that are in communication with one or more devices via a data network 911 exemplarily illustrated in the detailed description of FIG.9. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The method and the system 900 disclosed herein are not limited to a particular computer system platform, processor, operating system, or network. In an embodiment, one or more aspects of the method and the system 900 disclosed herein are distributed among one or more computer systems, for example, servers configured to provide one or more services to one or more client computers, or to perform a complete task in a distributed system. For example, one or more aspects of the method and the system 900 disclosed herein are performed on a client-server system that comprises components distributed among one or more server systems that perform multiple functions according to various embodiments. These components comprise, for example, executable, intermediate, or interpreted code, which communicate over the data network 911 using a communication protocol. The method and the system 900 disclosed herein are not limited to be executable on any particular system or group of systems, and are not limited to any particular distributed architecture, network, or communication protocol.

The foregoing examples have been provided merely for the purpose of explanation and are in no way to be construed as limiting of the method and the system 900 disclosed herein. While the method and the system 900 have been described with reference to various embodiments, it is understood that the words, which have been used herein, are words of description and illustration, rather than words of limitation. Further, although the method and the system 900 have been described herein with reference to particular means, materials, and embodiments, the method and the system 900 are not intended to be limited to the particulars disclosed herein; rather, the method and the system 900 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the system 900 disclosed herein in their aspects.

I claim:

1. An electronic device comprising a pace regulation system for regulating a pace of a user, the electronic device comprising:
a position tracking system configured to continuously track a position of the user wearing the electronic device on or near earth;
a movable projection system configured to project an image on earth at a distance and an angle computed by the pace regulation system;
a monitoring system configured to monitor vital signs of the user;
a non-transitory computer readable storage medium configured to store computer program instructions defined by the pace regulation system;
at least one processor communicatively coupled to the non-transitory computer readable storage medium, the at least one processor configured to execute the defined computer program instructions;
a touch-enabled display screen configured to display a graphical user interface provided by the pace regulation system;
wherein the pace regulation system comprises:
a user interface module configured to receive inputs from the user via the graphical user interface;
a computation module configured to continuously compute the distance and the angle for the projection of the image on the earth by the movable projection system based on the received inputs from the user and the continuously tracked position of the user from the position tracking system;
a positioning module configured to position the movable projection system based on the continuously computed distance and the continuously computed angle from the computation module;
the computation module further configured to calculate the pace of the user based on the continuously tracked position of the user from the position tracking system; and
the user interface module further configured to provide the graphical user interface to the touch-enabled display screen and display training information on the provided graphical user interface.

2. The electronic device of claim 1, wherein the received inputs from the user comprise a desired pace and a desired starting point.

3. The electronic device of claim 2, wherein the pace regulation system is further configured to stop the projection of the image by the movable projection system when a differential between the desired pace and the pace of the user calculated by the computation module is outside a preconfigured pace differential.

4. The electronic device of claim 1, wherein the position tracking system tracks the position of the user using one or more of global positioning system and wireless networks.

5. The electronic device of claim 1, wherein the computation module is further configured to synthesize the training information displayed by the user interface module on the provided graphical user interface.

6. The electronic device of claim 5, wherein the synthesized training information comprises the inputs received from the user, duration of training, the pace of the user, calories burned by the user, the vital signs of the user monitored by the monitoring system, distance covered by the user, and time of day.

7. The electronic device of claim 1, wherein the electronic device is secured to the user by one of a plurality of fastening methods.

8. An electronic device comprising a pace regulation system for regulating a pace of a user wearing the electronic device, the electronic device comprising:
a communication system configured to continuously communicate with a user device;
a movable projection system configured to project an image on earth at a distance and an angle computed by the pace regulation system;
a non-transitory computer readable storage medium configured to store computer program instructions defined by the pace regulation system;
at least one processor communicatively coupled to the non-transitory computer readable storage medium, wherein the processor is configured to execute the defined computer program instructions; and
the pace regulation system comprising:
an acquisition module configured to continuously acquire a position of the user wearing the electronic device on or near earth and acquire inputs from the user from the user device via the communication system;
a computation module configured to continuously compute the distance and the angle for the projection of the image on the earth by the movable projection system based on the continuously acquired position of the user and the acquired inputs from the user;
a positioning module configured to position the movable projection system based on the continuously computed distance and the continuously computed angle from the computation module; and
the computation module further configured to calculate the pace of the user based on the continuously acquired position of the user.

9. The electronic device of claim 8, wherein the acquired inputs from the user comprise a desired pace and a desired starting point.

10. The electronic device of claim 9, wherein the pace regulation system is further configured to stop the projection of the image by the movable projection system when a differential between the desired pace and the pace of the user calculated by the computation module is outside a preconfigured pace differential.

11. The electronic device of claim 8, wherein the electronic device is secured to the user by one of a plurality of fastening methods.

12. A method for regulating a pace of a user, the method comprising a pace regulation system executable by at least one processor configured to execute computer program instructions for performing the method, the method comprising:
receiving inputs from the user;
continuously tracking a position of the user on earth;
computing a distance and an angle for projection of an image on earth at a position relative to the continuously tracked position of the user based on the received inputs from the user;
calculating the pace of the user from the continuously tracked position of the user on earth;
updating the position of the image based on the calculated pace of the user; and
synthesizing training information for display on a graphical user interface.

13. The method of claim 12, wherein the received inputs from the user comprise a desired pace and a desired starting point.

14. The method of claim 13, wherein the updating of the position of the image comprises stopping the projection of the image when a differential between the desired pace and the calculated pace of the user is outside a preconfigured pace differential.

15. The method of claim 12, wherein the pace regulation system tracks the position of the user using one or more of global positioning system and wireless networks.

16. The method of claim 12, wherein the synthesized training information comprises the inputs received from the user, duration of training, the calculated pace of the user, calories burned by the user, vital signs of the user, distance covered by the user, and time of day.

17. A system for regulating a pace of a user, the system comprising:
non-transitory computer readable storage media for storing computer program instructions defined by modules of the system;
processors communicatively coupled to the non-transitory computer readable storage media, the processors configured to execute the defined computer program instructions;
a pace regulation system for regulating the pace of the user and executable by at least one of the processors configured to execute computer program instructions defined by modules of the pace regulation system, the modules of the pace regulation system comprising:
a user interface module for receiving inputs from the user via the graphical user interface;
a computation module for continuously computing the distance and the angle for the projection of the image on the earth by the movable projection system based on the received inputs from the user and the continuously tracked position of the user from the position tracking system; and
a positioning module for positioning the movable projection system based on the continuously computed distance and the continuously computed angle from the computation module.

18. The system of claim 17, wherein the user interface module further comprise for providing the graphical user interface to the touch-enabled display screen and display training information on the provided graphical user interface.

19. The system of claim 17, wherein the computation module further comprise for calculating the pace of the user based on the continuously tracked position of the user from the position tracking system.

20. The system of claim 17, wherein the computation module further comprises for synthesizing the training information displayed by the user interface module on the provided graphical user interface.

21. The system of claim 17, wherein the modules of the pace regulation system further comprise stopping the projection of the image by the movable projection system when a differential between the desired pace and the pace of the user calculated by the computation module is outside a preconfigured pace differential.

22. A non-transitory computer readable storage medium having embodied thereon, computer program codes comprising instructions executable by at least one processor for regulating a pace of a user, said computer program codes comprising:
a first computer program code for receiving inputs from the user;
a second computer program code for continuously tracking a position of the user on earth;
a third computer program code for computing a distance and an angle for projection of an image on earth at a position relative to the continuously tracked position of the user based on the received inputs from the user;
a fourth computer program code for calculating the pace of the user from the continuously tracked position of the user on earth;
a fifth computer program code for updating the position of the image based on the calculated pace of the user; and
a sixth computer program code for synthesizing training information for display on a graphical user interface.

23. The non-transitory computer readable storage medium of claim 22, wherein the first computer program code further comprises a seventh program code for providing the graphical user interface to the touch-enabled display screen and display training information on the provided graphical user interface.

24. The non-transitory computer readable storage medium of claim 22, wherein the third computer program code further comprises an eighth program code for calculating the pace of the user based on the continuously tracked position of the user from the position tracking system.

25. The non-transitory computer readable storage medium of claim 22, wherein the third computer program code further comprises a ninth program code for synthesizing the training information displayed by the user interface module on the provided graphical user interface.
